(19) United States
(12) Patent Application Publication
(10) Pub. No.: US 2026/0196408 A1
(43) Pub. Date: Jul. 9, 2026

(54) MULTILAYER CERAMIC CAPACITOR

(71) Applicant: Murata Manufacturing Co., Ltd., Nagaokakyo-shi (JP)

(72) Inventors: Yukie WATANABE, Nagaokakyo-shi (JP); Satoshi MURAMATSU, Nagaokakyo-shi (JP); Jun KURITANI, Nagaokakyo-shi (JP); Ken TOMINAGA, Nagaokakyo-shi (JP); Tatsunori YASUDA, Nagaokakyo-shi (JP)

(21) Appl. No.: 19/550,639

(22) Filed: Feb. 26, 2026

Related U.S. Application Data
(63) Continuation of application No. PCT/JP2024/015503, filed on Apr. 19, 2024.

(30) Foreign Application Priority Data
Oct. 2, 2023 (JP) 2023-171205

(51) Int. Cl. H01G 2/24; H01G 4/12; H01G 4/232; H01G 4/248; H01G 4/30

(52) U.S. Cl. CPC H01G 2/24; H01G 4/232; H01G 4/248; H01G 4/306; H01G 4/12

(57) ABSTRACT

In a multilayer ceramic capacitor, in each of first through fourth outer electrodes on a first main surface and/or a second main surface of a multilayer body, as viewed in a stacking direction, straight lines are drawn in parallel to a first direction and in parallel to a second direction from an intersection point between each of the first through fourth outer electrodes and the multilayer body. In at least one of the first through fourth outer electrodes, at least one recess protrudes inward from an outer edge of a region defined by the straight lines, and inward from an edge portion of the at least one of the first through fourth outer electrodes, the edge portion being at or adjacent to a center of the multilayer body.

### CROSS REFERENCE TO RELATED APPLICATIONS

This application claims the benefit of priority to Japanese Patent Application No. 2023-171205 filed on Oct. 2, 2023 and is a Continuation Application of PCT Application No. PCT/JP 2024/015503 filed on Apr. 19, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

There is a demand for thinner multilayer ceramic capacitors in accordance with the recent miniaturization of electronic devices incorporating multilayer ceramic capacitors.

For example, Japanese Unexamined Patent Application Publication No. 2020-136363 discloses a multilayer ceramic capacitor having a dimension of less than 0.3 mm in a stacking direction of the layers. In this multilayer ceramic capacitor, an outer electrode formed on a multilayer body includes an underlying film, which is made of a sintered metal film, and a plating film disposed thereon.

Japanese Unexamined Patent Application Publication No. 2021-103730 discloses the following multilayer ceramic capacitor. Two adjacent sides of the multilayer ceramic capacitor are defined as first and second sides, and the ratio of the length of the first side to that of the second side is 0.9 to 1.1.

### SUMMARY OF THE INVENTION

When multilayer ceramic capacitors are viewed in the stacking direction of the layers, outer electrodes have the same shape. This may cause multilayer ceramic capacitors having different capacitance values to be mixed together. Marks may be applied to multilayer ceramic capacitors by capacitance. Depending on the material or the shape of the marks, however, the outer electrodes may be electrically connected to each other, or a multilayer ceramic capacitor may break during marking because of its small dimension in the stacking direction.

Accordingly, example embodiments of the present invention provide multilayer ceramic capacitors each with specifications and certain characteristics that can be determined when the multilayer ceramic capacitor is viewed in a stacking direction of layers.

A multilayer ceramic capacitor according to an example embodiment of the present invention includes a multilayer body including first and second main surfaces opposing each other in a stacking direction of layers, first and second side surfaces opposing each other in a first direction, the first direction being perpendicular to the stacking direction, and third and fourth side surfaces opposing each other in a second direction, the second direction being perpendicular to the stacking direction and the first direction, a first outer electrode on the first and third side surfaces and on the first main surface and/or the second main surface, a second outer electrode on the second and third side surfaces and on the first main surface and/or the second main surface, a third outer electrode on the first and fourth side surfaces and on the first main surface and/or the second main surface, and a fourth outer electrode on the second and fourth side surfaces and on the first main surface and/or the second main surface. In each of the first through fourth outer electrodes on the first main surface and/or the second main surface, as viewed in the stacking direction, straight lines are drawn in parallel to the first direction and in parallel to the second direction from an intersection point between each of the first through fourth outer electrodes and the multilayer body, and, in at least one of the first through fourth outer electrodes, at least one recess protrudes inward from an outer edge of a region defined by the straight lines, and inward from an edge portion of the at least one of the first through fourth outer electrodes, the edge portion being at or adjacent to a center of the multilayer body.

In a multilayer ceramic capacitor according to an example embodiment of the present invention, in each of the first through fourth outer electrodes on the first main surface and/or the second main surface, as viewed in the stacking direction, straight lines are drawn in parallel to the first direction and in parallel to the second direction from an intersection point between each of the first through fourth outer electrodes and the multilayer body, and, in at least one of the first through fourth outer electrodes, at least one recess protrudes inward from an outer edge of a region defined by the straight lines, and inward from an edge portion of the at least one of the first through fourth outer electrodes, the edge portion being at or adjacent to a center of the multilayer body. With this configuration, by checking the presence/absence and the size of the recess with an image sensor or another device, the specifications and certain characteristics of the multilayer ceramic capacitor can be determined.

According to example embodiments of the present invention, it is possible to provide multilayer ceramic capacitors each with specifications and certain characteristics that can be determined when the multilayer ceramic capacitor is viewed in a stacking direction of layers.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to a first example embodiment of the present invention.

FIG. 2 is a front view illustrating an example of the multilayer ceramic capacitor according to the first example embodiment of the present invention.

FIG. 3 is a side view illustrating an example of the multilayer ceramic capacitor according to the first example embodiment of the present invention.

FIG. 4A is a plan view illustrating an example of the multilayer ceramic capacitor according to the first example embodiment of the present invention.

FIG. 4B(a) is a plan view illustrating a state in which a thin film layer is disposed on a first main surface of a multilayer body, and

FIG. 4B(b) is a plan view illustrating a state in which a lower plating layer is disposed on the first main surface of the multilayer body.

FIG. 4C(a) illustrates another arrangement example of a recess provided in an outer electrode of the multilayer ceramic capacitor according to the first example embodiment of the present invention, FIG. 4C(b) illustrates still another arrangement example of recesses provided in the outer electrode, and FIG. 4C(c) illustrates still another arrangement example of recesses provided in the outer electrode.

FIG. 5 is a schematic sectional view taken along line V-V in FIG. 1.

FIG. 6 is a schematic sectional view taken along line VI-VI in FIG. 1.

FIG. 7 is a schematic sectional view taken along line VII-VII FIG. 1.

FIG. 8 is a schematic sectional view taken along line VIII-VIII in FIG. 1.

FIG. 9 is a schematic sectional view taken along line IX-IX in FIG. 1.

FIG. 10 is an exploded perspective view of the multilayer body shown in FIG. 1.

FIG. 11 is a schematic sectional view illustrating an example of a multilayer ceramic capacitor according to a first modified example of the first example embodiment of the present invention.

FIG. 12 is a schematic sectional view illustrating an example of a multilayer ceramic capacitor according to a second modified example of the first example embodiment of the present invention.

FIG. 13 is a schematic sectional view illustrating an example of a multilayer ceramic capacitor according to a third modified example of the first example embodiment of the present invention.

FIG. 14 is an external perspective view illustrating an example of a multilayer ceramic capacitor according to a second example embodiment of the present invention when the multilayer ceramic capacitor is viewed from one side.

FIG. 15 is an external perspective view illustrating an example of the multilayer ceramic capacitor according to the second example embodiment of the present invention when the multilayer ceramic capacitor is viewed from another side.

FIG. 16 is a plan view illustrating an example of the multilayer ceramic capacitor according to the second example embodiment of the present invention.

FIG. 17 is a schematic sectional view taken along line XVII-XVII in FIG. 14 and illustrates the structure of an example of the multilayer ceramic capacitor according to the second example embodiment of the present invention.

FIG. 18 is a schematic sectional view taken along line XVIII-XVIII in FIG. 14.

FIG. 19 is a schematic sectional view taken along line XIX-XIX in FIG. 14.

FIG. 20 is a schematic sectional view taken along line XX-XX in FIG. 14.

### DETAILED DESCRIPTION OF THE EXAMPLE EMBODIMENTS

Examples of multilayer ceramic capacitors according to example embodiments of the present invention will now be described below.

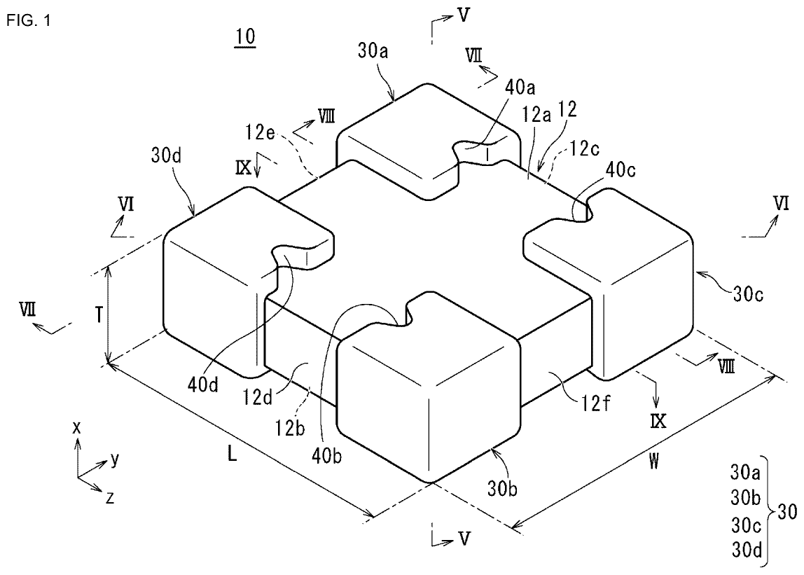

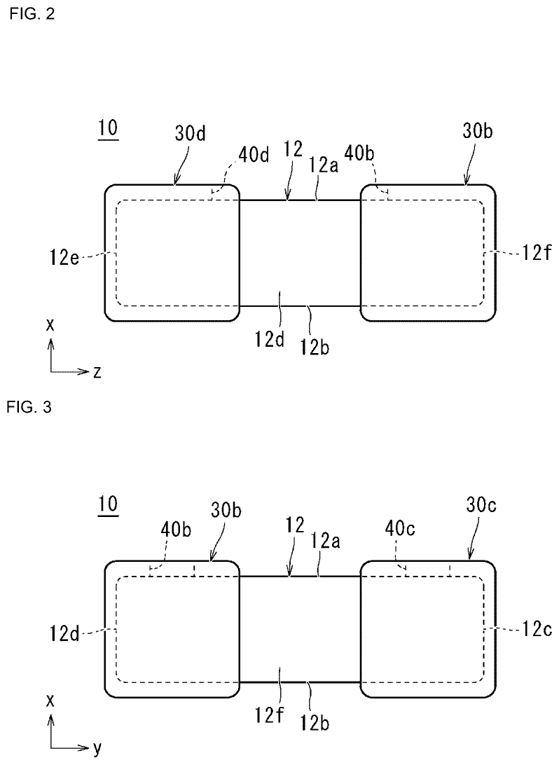

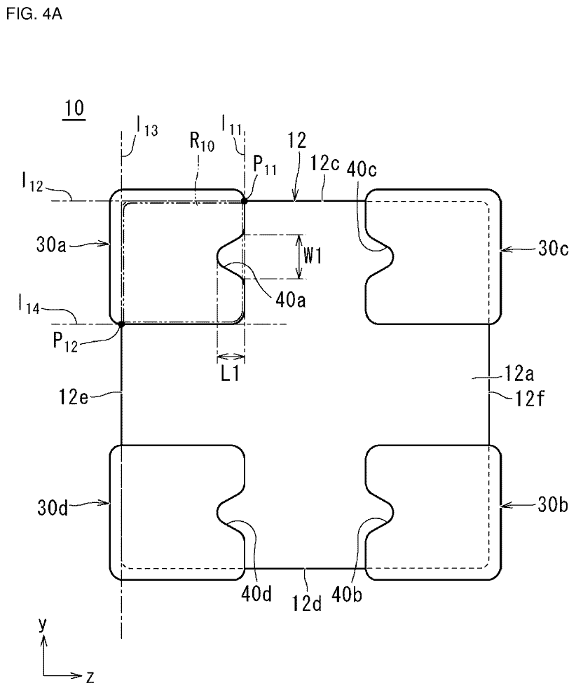

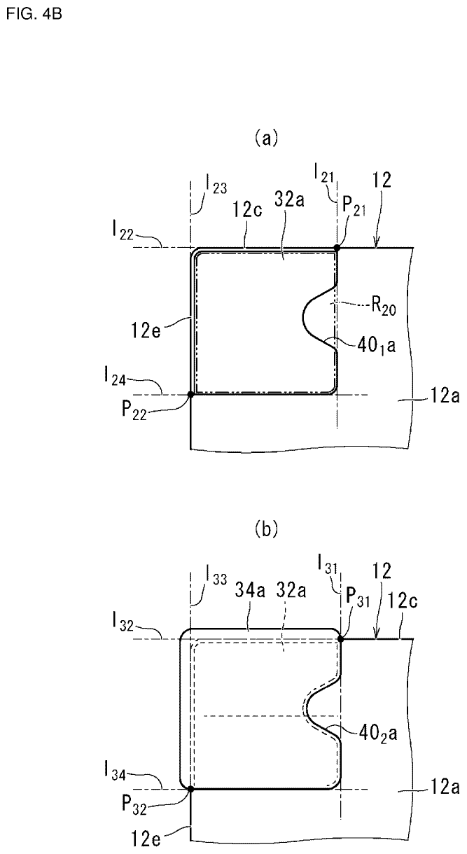

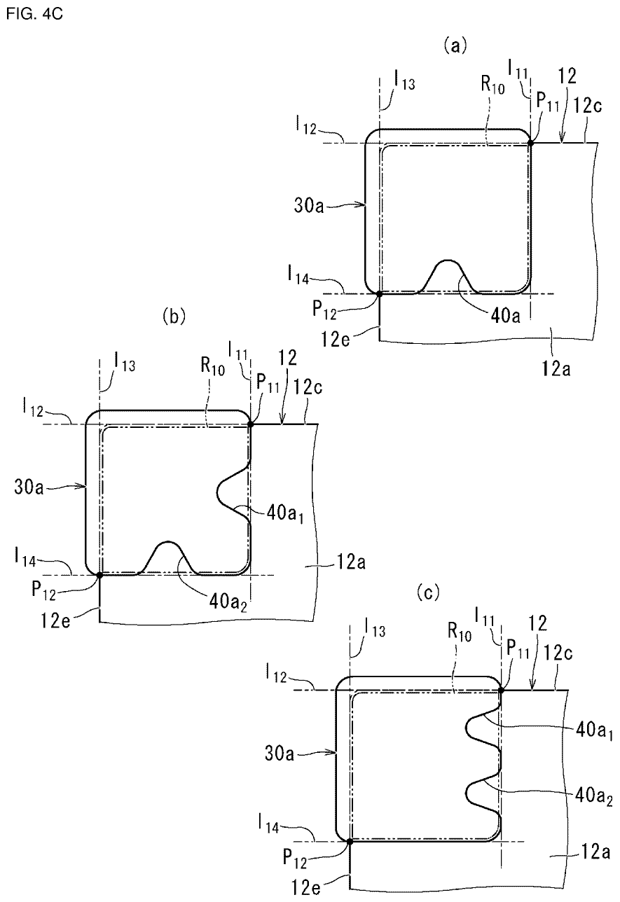

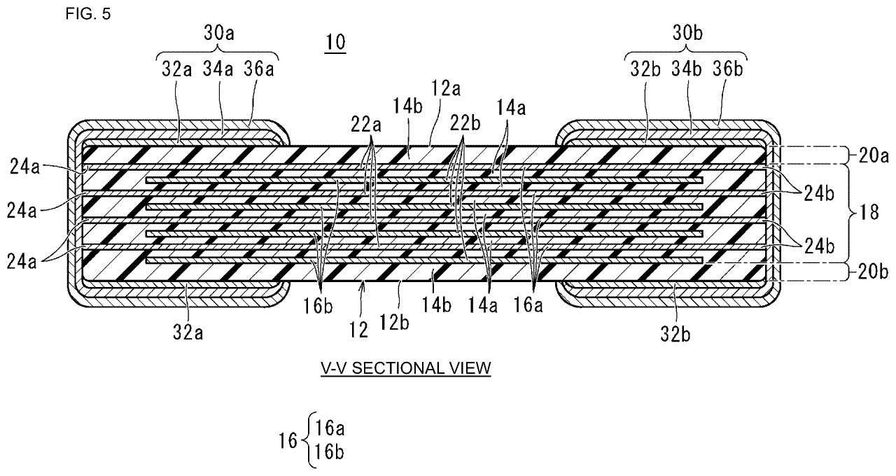

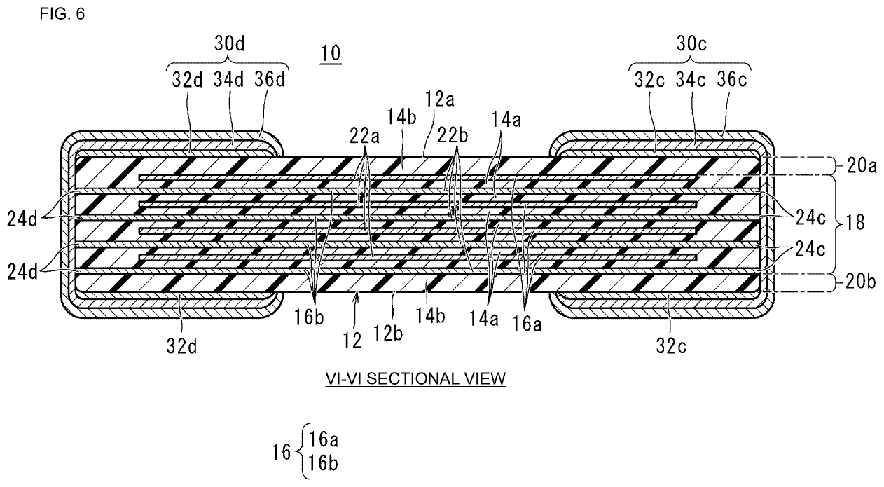

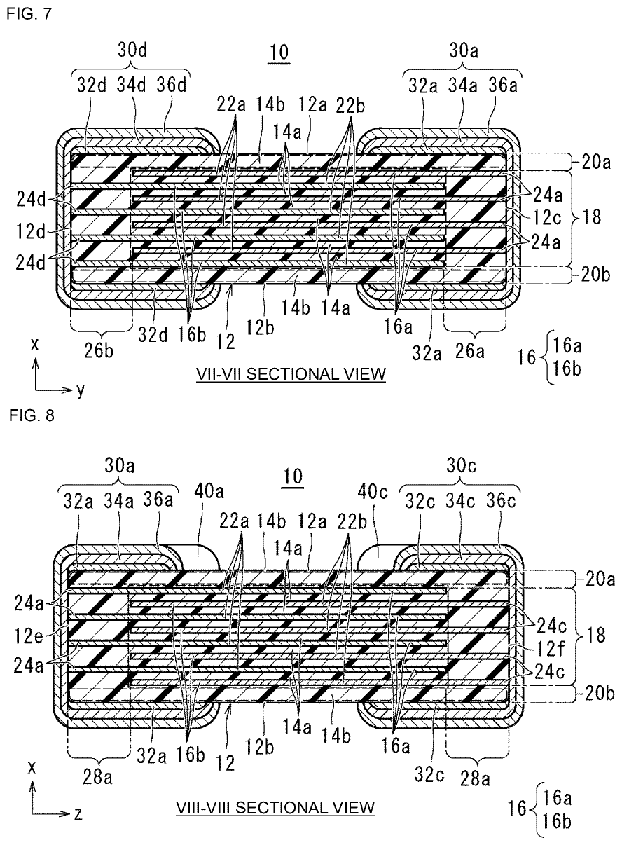

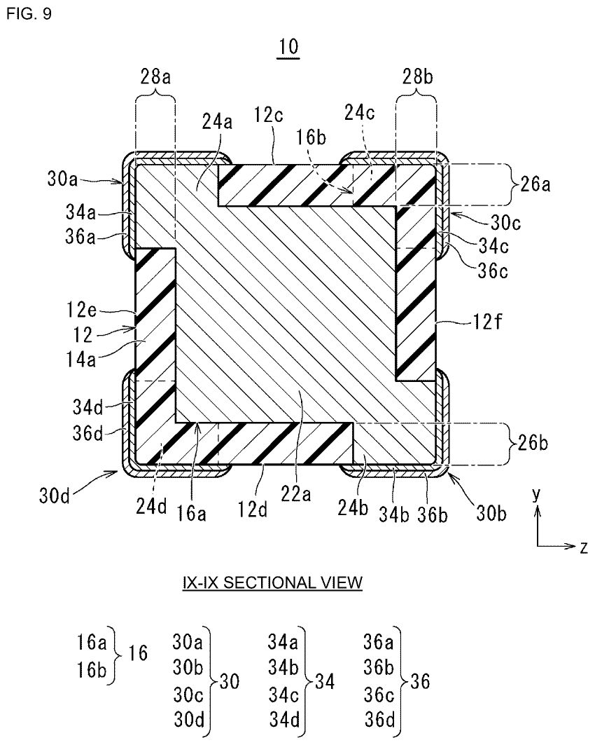

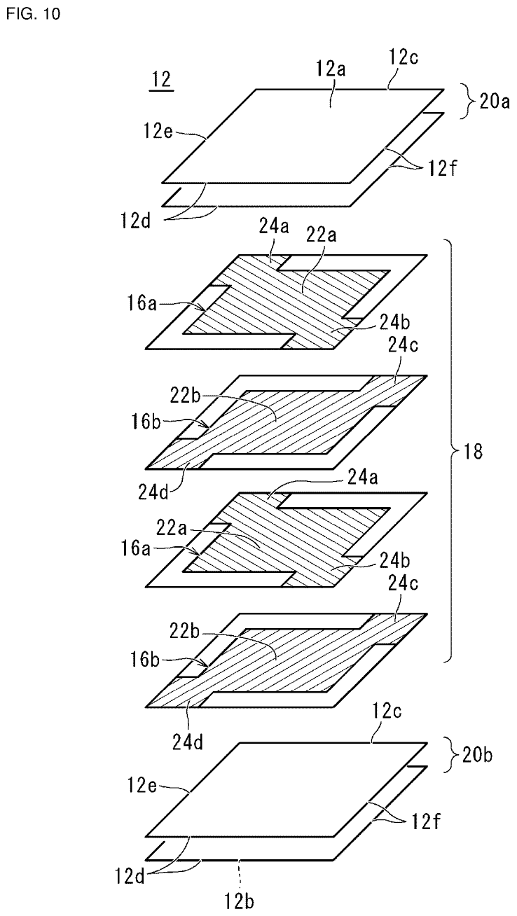

FIG. 1 is an external perspective view illustrating an example of a multilayer ceramic capacitor according to a first example embodiment of the present invention. FIG. 2 is a front view illustrating an example of the multilayer ceramic capacitor according to the first example embodiment of the present invention. FIG. 3 is a side view illustrating an example of the multilayer ceramic capacitor according to the first example embodiment of the present invention. FIG. 4A is a plan view illustrating an example of the multilayer ceramic capacitor according to the first example embodiment of the present invention. FIG. 4B(a) is a plan view illustrating a state in which a thin film layer is disposed on a first main surface of a multilayer body. FIG. 4B(b) is a plan view illustrating a state in which a lower plating layer is disposed on the first main surface of the multilayer body. FIG. 4C(a) illustrates another arrangement example of a recess provided in an outer electrode of the multilayer ceramic capacitor according to the first example embodiment of the present invention. FIG. 4C(b) illustrates still another arrangement example of recesses provided in the outer electrode. FIG. 4C(c) illustrates still another arrangement example of recesses provided in the outer electrode. FIG. 5 is a schematic sectional view taken along line V-V in FIG. 1. FIG. 6 is a schematic sectional view taken along line VI-VI in FIG. 1. FIG. 7 is a schematic sectional view taken along line VII-VII in FIG. 1. FIG. 8 is a schematic sectional view taken along line VIII-VIII in FIG. 1. FIG. 9 is a schematic sectional view taken along line IX-IX in FIG. 1. FIG. 10 is an exploded perspective view of the multilayer body shown in FIG. 1.

The multilayer ceramic capacitor 10 includes a multilayer body 12 and multiple outer electrodes 30.

The multilayer body 12 includes a first main surface 12a and a second main surface 12b opposing each other in a stacking direction x, a first side surface 12c and a second side surface 12d opposing each other in a first direction y that is perpendicular to the stacking direction x, and a third side surface 12e and a fourth side surface 12f opposing each other in a second direction z that is perpendicular to the stacking direction x and the first direction y. The direction in which the first main surface 12a and the second main surface 12b of the multilayer body 12 are connected to each other is the stacking direction x.

The corners and the ridge portions of the multilayer body 12 are preferably rounded. The corner is a portion at which three adjacent surfaces of the multilayer body 12 intersect each other. The ridge portion is a portion at which two adjacent surfaces of the multilayer body 12 intersect each other. Irregularities, for example, may be provided on some or all of the first and second main surfaces 12a and 12b, the first and second side surfaces 12c and 12d, and the third and fourth side surfaces 12e and 12f.

The multilayer body 12 includes multiple dielectric layers 14 and multiple inner electrodes 16. The dielectric layers 14 include inner dielectric layers 14a and outer dielectric layers 14b. The inner electrodes 16 include first inner electrodes 16a and second inner electrodes 16b.

The multilayer body 12 also includes an inner layer section 18, a first outer layer section 20a facing the first main surface 12a, and a second outer layer section 20b facing the second main surface 12b.

The first outer layer section 20a faces the first main surface 12a of the multilayer body 12 and includes the multiple outer dielectric layers 14b between the first main surface 12a and the inner electrode 16 positioned closest to the first main surface 12a.

The second outer layer section 20b faces the second main surface 12b of the multilayer body 12 and includes the multiple outer dielectric layers 14b between the second main surface 12b and the inner electrode 16 positioned closest to the second main surface 12b.

The region sandwiched between the first and second outer layer sections 20a and 20b is the inner layer section 18.

The inner layer section 18 includes the inner dielectric layers 14a, the first inner electrodes 16a that are each exposed at one end to the first and third side surfaces 12c and 12e and each exposed at the other end to the second and fourth side surfaces 12d and 12f, and the second inner electrodes 16b that are each exposed at one end to the first and fourth side surfaces 12c and 12f and each exposed at the other end to the second and third side surfaces 12d and 12e.

The dielectric layers 14 may include a dielectric material, for example. As the dielectric material, a dielectric ceramic material composed of BaTiO₃, CaTiO₃, SrTiO₃, or CaZrO₃, as a main component, for example, may be used. A dielectric ceramic material obtained by adding a subcomponent, such as a Mn compound, a Fe compound, a Cr compound, a Co compound, or a Ni compound, to such main components may be used. The inner dielectric layers 14a and the outer dielectric layers 14b may include the same dielectric material or may include different dielectric materials to differentiate between the function of the inner layer section 18 and that of the outer layer sections 20a and 20b. At least one of Si, Mg, Ba, and Mn may be added as an additive. The additive is present between ceramic particles.

If the inner dielectric layers 14a include a large amount of CaTiO₃ or CaZrO₃ as a dielectric component, dielectric breakdown is less likely to occur between the first inner electrodes 16a and the second inner electrodes 16b. The above-described materials are only examples, and the inner dielectric layers 14a may use a different main component, such as SrTiO₃. If it is desired to enhance the capacitance of the multilayer ceramic capacitor 10, the inner dielectric layers 14a preferably include a material having a high dielectric constant, such as BaTiO₃.

The dielectric layers 14 may include multiple crystal grains with a perovskite structure based on BaTiO₃, for example.

The dielectric layers 14 having a smaller thickness enhances the capacitance of the multilayer ceramic capacitor 10, and the crystal grain size is thus preferably about 1 μm or smaller, for example.

The number of dielectric layers 14 to be stacked is not particularly limited, but is preferably three to 700, for example, including dielectric layers 14 forming the first and second outer layer sections 20a and 20b. The thickness of the inner dielectric layers 14a is preferably about 0.4 μm to about 2.0 μm, and the thickness of the outer dielectric layers 14b is preferably about 2.0 μm to about 100.0 μm, for example.

The inner electrodes 16 include multiple first inner electrodes 16a and multiple second inner electrodes 16b. The first inner electrodes 16a and the second inner electrodes 16b are alternately stacked on each other with the corresponding dielectric layers 14 interposed therebetween.

The first inner electrodes 16a are each provided on the front surface of the corresponding dielectric layer 14. The first inner electrodes 16a include first opposing electrode portions 22a which oppose the first and second main surfaces 12a and 12b and oppose the corresponding second inner electrodes 16b. The first inner electrodes 16a are stacked on each other in the direction in which the first and second main surfaces 12a and 12b are connected to each other.

The first inner electrodes 16a extend to the first side surface 12c and the third side surface 12e of the multilayer body 12 via first extending electrode portions 24a and extend to the second side surface 12d and the fourth side surface 12f of the multilayer body 12 via second extending electrode portions 24b. The length by which the first extending electrode portions 24a extend to the first side surface 12c may be substantially equal to the length by which the first extending electrode portions 24a extend to the third side surface 12e. The length by which the second extending electrode portions 24b extend to the second side surface 12d may be substantially equal to the length by which the second extending electrode portions 24b extend to the fourth side surface 12f.

The first inner electrodes 16a continuously extend to the first and third side surfaces 12c and 12e of the multilayer body 12 via the first extending electrode portions 24a and continuously extend to the second and fourth side surfaces 12d and 12f of the multilayer body 12 via the second extending electrode portions 24b. Alternatively, the first inner electrodes 16a may extend discontinuously. The first inner electrodes 16a may be exposed to only one of the first through fourth side surfaces 12c through 12f.

The second inner electrodes 16b are each provided on the front surface of the corresponding inner dielectric layer 14a which is different from the inner dielectric layers 14a on which the first inner electrodes 16a are disposed. The second inner electrodes 16b include second opposing electrode portions 22b which oppose the first and second main surfaces 12a and 12b and oppose the corresponding first inner electrodes 16a. The second inner electrodes 16b are stacked on each other in the direction in which the first and second main surfaces 12a and 12b are connected to each other.

The second inner electrodes 16b extend to the first side surface 12c and the fourth side surface 12f of the multilayer body 12 via third extending electrode portions 24c and extend to the second side surface 12d and the third side surface 12e of the multilayer body 12 via fourth extending electrode portions 24d. The length by which the third extending electrode portions 24c extend to the first side surface 12c may be substantially equal to the length by which the third extending electrode portions 24c extend to the fourth side surface 12f. The length by which the fourth extending electrode portions 24d extend to the second side surface 12d may be substantially equal to the length by which the fourth extending electrode portions 24d extend to the third side surface 12e.

The second inner electrodes 16b continuously extend to the first and fourth side surfaces 12c and 12f of the multilayer body 12 via the third extending electrode portions 24c and continuously extend to the second and third side surfaces 12d and 12e of the multilayer body 12 via the fourth extending electrode portions 24d. Alternatively, the second inner electrodes 16b may extend discontinuously. The second inner electrodes 16b may be exposed to only one of the first through fourth side surfaces 12c through 12f.

When the multilayer ceramic capacitor 10 is viewed in the stacking direction, a line connecting the first and second extending electrode portions 24a and 24b of the first inner electrodes 16a and a line connecting the third and fourth extending electrode portions 24c and 24d of the second inner electrodes 16b preferably intersect each other.

As illustrated in FIG. 7, the multilayer body 12 also includes a side portion (W gap) 26a of the multilayer body 12 positioned between the first side surface 12c and one end of each of the second opposing electrode portions 22b of the second inner electrodes 16b in the first direction y and a side portion (W gap) 26b of the multilayer body 12 positioned between the second side surface 12d and the other end of each of the first opposing electrode portions 22a of the first inner electrodes 16a in the first direction y.

As illustrated in FIG. 8, the multilayer body 12 also includes an end portion (L gap) 28a of the multilayer body 12 positioned between the third side surface 12e and one end of each of the second opposing electrode portions 22b of the second inner electrodes 16b in the second direction z and an end portion (L gap) 28b of the multilayer body 12 positioned between the fourth side surface 12f and the other end of each of the first opposing electrode portions 22a of the first inner electrodes 16a in the second direction z.

The first and second inner electrodes 16a and 16b may include suitable conductive material, for example, a metal, such as Ni, Cu, Ag, Pd, and Au, or an alloy including at least one of such metals, such as a Ni—Cu alloy and an Ag—Pd alloy. However, the material of the first and second inner electrodes 16a and 16b is not limited to these materials. The first and second inner electrodes 16a and 16b may include the same conductive material or may include different conductive materials.

If the first and second inner electrodes 16a and 16b include Sn, the potential barrier height at the interface between the inner electrodes 16 and the dielectric layers 14 is increased. This can alleviate the concentration of an electric field on the interface between the inner electrodes 16 and the dielectric layers 14, which leads to improved reliability under high temperature loads. In this case, even if Sn is included in only one of the first and second inner electrodes 16a and 16b, sufficient effects can be exhibited.

The total number of first and second inner electrodes 16a and 16b is preferably three to 700, for example. The thickness of the first and second inner electrodes 16a and 16b is not particularly limited, but is preferably about 0.2 μm to about 2.0 μm, for example.

The outer electrodes 30 are disposed on the multilayer body 12, as illustrated in FIGS. 1 through 9.

The outer electrodes 30 include multiple outer electrodes 30 connected to the first and second inner electrodes 16a and 16b. The outer electrodes 30 include a first outer electrode 30a, a second outer electrode 30b, a third outer electrode 30c, and a fourth outer electrode 30d.

The first outer electrode 30a covers the first extending electrode portions 24a of the first inner electrodes 16a on the first and third side surfaces 12c and 12e and also covers a portion of the first main surface 12a and a portion of the second main surface 12b. The first outer electrode 30a is electrically connected to the first extending electrode portions 24a of the first inner electrodes 16a.

The second outer electrode 30b covers the second extending electrode portions 24b of the first inner electrodes 16a on the second and fourth side surfaces 12d and 12f and also covers a portion of the first main surface 12a and a portion of the second main surface 12b. The second outer electrode 30b is electrically connected to the second extending electrode portions 24b of the first inner electrodes 16a.

The third outer electrode 30c covers the third extending electrode portions 24c of the second inner electrodes 16b on the first and fourth side surfaces 12c and 12f and also covers a portion of the first main surface 12a and a portion of the second main surface 12b. The third outer electrode 30c is electrically connected to the third extending electrode portions 24c of the second inner electrodes 16b.

The fourth outer electrode 30d covers the fourth extending electrode portions 24d of the second inner electrodes 16b on the second and third side surfaces 12d and 12e and also covers a portion of the first main surface 12a and a portion of the second main surface 12b. The fourth outer electrode 30d is electrically connected to the fourth extending electrode portions 24d of the second inner electrodes 16b.

Within the multilayer body 12, the first opposing electrode portions 22a of the first inner electrodes 16a and the second opposing electrode portions 22b of the second inner electrodes 16b face each other via the corresponding inner dielectric layers 14a, thus generating electrostatic capacitance. Accordingly, electrostatic capacitance can be generated between the first and second outer electrodes 30a and 30b connected to the first inner electrodes 16a and the third and fourth outer electrodes 30c and 30d connected to the second inner electrodes 16b, so that the characteristics of a capacitor are exhibited.

Each of the first through fourth outer electrodes 30a through 30d preferably includes a thin film layer 32, a lower plating layer 34, and an upper plating layer 36.

This will be more specifically discussed. The first outer electrode 30a preferably includes a first thin film layer 32a, a first lower plating layer 34a, and a first upper plating layer 36a. The second outer electrode 30b preferably includes a second thin film layer 32b, a second lower plating layer 34b, and a second upper plating layer 36b. The third outer electrode 30c preferably includes a third thin film layer 32c, a third lower plating layer 34c, and a third upper plating layer 36c. The fourth outer electrode 30d preferably includes a fourth thin film layer 32d, a fourth lower plating layer 34d, and a fourth upper plating layer 36d.

The thin film layers 32 include the first thin film layer 32a, second thin film layer 32b, third thin film layer 32c, and fourth thin film layer 32d.

The first thin film layer 32a covers a portion of the first main surface 12a and a portion of the second main surface 12b of the multilayer body 12 that are close to the first and third side surfaces 12c and 12e and not to cover the first and third side surfaces 12c and 12e.

The second thin film layer 32b covers a portion of the first main surface 12a and a portion of the second main surface 12b of the multilayer body 12 that are close to the second and fourth side surfaces 12d and 12f and not to cover the second and fourth side surfaces 12d and 12f.

The third thin film layer 32c covers a portion of the first main surface 12a and a portion of the second main surface 12b of the multilayer body 12 that are close to the first and fourth side surfaces 12c and 12f and not to cover the first and fourth side surfaces 12c and 12f.

The fourth thin film layer 32d covers a portion of the first main surface 12a and a portion of the second main surface 12b of the multilayer body 12 that are close to the third and second side surfaces 12e and 12d and not to cover the third and second side surfaces 12e and 12d.

Each of the first through fourth thin film layers 32a through 32d is preferably formed by the deposition of metal particles using sputtering, vapor deposition, or another technique. With this configuration, the thickness of the first through fourth thin film layers 32a through 32d in the connecting direction of the first and second main surfaces 12a and 12b of the multilayer body 12 can be set to about 1 μm or smaller, for example. This can sufficiently reduce the dimension of the multilayer ceramic capacitor 10 in the stacking direction x, thus making the multilayer ceramic capacitor 10 thinner.

The dimensions of the first through fourth thin film layers 32a through 32d in the stacking direction x can be measured as follows. When the thin film layers are formed by the deposition of metal particles, an X-ray fluorescence spectrometer is used, and the density of a predetermined metal is obtained and is converted into the thickness from a calibration curve of this metal. Alternatively, a cross section of the thin film layer may be prepared by FIB and be observed with a scanning electron microscope, thus measuring the thickness from an actual image.

When the first through fourth thin film layers 32a through 32d are formed by a certain thin film forming method, they are preferably made of a metal, such as Cu and Ni.

The thin film layers 32 of the multilayer ceramic capacitor 10 shown in FIG. 1 are formed by the deposition of metal particles using sputtering. When the thickness of the thin film layers 32 is about 1 μm or smaller, for example, the dimension of the multilayer ceramic capacitor 10 in the stacking direction x can be sufficiently reduced.

The first through fourth thin film layers 32a through 32d may formed by taking the individual functions into account. For example, the first through fourth thin film layers 32a through 32d are preferably made of NiCr or NiCu as a main component in terms of the adhesion with the multilayer body 12. Each of the first through fourth thin film layers 32a through 32d may have multiple layers, such as a double layer structure of NiCr and NiCu.

The thin film layers 32 may be those including a dielectric material and a metal component formed by screen printing. In this case, the thin film layers 32 and the ceramic component of the multilayer body 12 firmly adhere to each other, thus enhancing the adhesion between the multilayer body 12 and the outer electrodes 30. In addition to a metal component, the thin film layers 32 may include the same ceramic component as the main component of the inner dielectric layers 14a. The ceramic component included in the thin film layers 32 can reduce the difference in the coefficient of thermal expansion between the multilayer body 12 and the thin film layers 32, thus easing a stress applied to the thin film layers 32. The thin film layers 32 may include a metal component other than Cu and Ni. The thin film layers 32 may include a glass component, as well as a ceramic component. Examples of the glass component are oxides, such as those of Ba (barium), Sr (strontium), Si (silicon), Ca (calcium), Zn, Al, and B (boron). As a metal component other than Cu and Ni, Mg, Cr, Sr, Al, Na, and Fe may be included. The thin film layers 32 may have a discontinuous shape. This means that the thin film layers 32 may be formed discontinuously as they are seen from the longitudinal direction and the vertical direction.

When the thin film layers 32 are formed by adding a ceramic material, the thickness may be measured as follows. After a cross section of the thin film layer 32 is polished, a photo of this cross section is taken with a digital microscope (made by KEYENCE CORPORATION: VHX-5000), for example, and then, the thickness is determined from the photo and is then converted. Alternatively, a cross section of the thin film layer 32 may be prepared by FIB and be observed with a scanning electron microscope, thus measuring the thickness from an actual image.

The lower plating layers 34 include the first lower plating layer 34a, second lower plating layer 34b, third lower plating layer 34c, and fourth lower plating layer 34d.

The first lower plating layer 34a covers the first thin film layer 32a and the first and third side surfaces 12c and 12e of the multilayer body 12.

The second lower plating layer 34b covers the second thin film layer 32b and the second and fourth side surfaces 12d and 12f of the multilayer body 12.

The third lower plating layer 34c covers the third thin film layer 32c and the first and fourth side surfaces 12c and 12f of the multilayer body 12.

The fourth lower plating layer 34d covers the fourth thin film layer 32d and the second and third side surfaces 12d and 12e of the multilayer body 12.

The lower plating layers 34 include at least one of elements selected from Cu, Ni, Sn, Ag, Pd, an Ag—Pd alloy, and Au, for example. The lower plating layers 34 are preferably Cu-plating layers. In this case, the lower plating layers 34 may be directly connected to the inner electrodes 16. The lower plating layers 34 may include another Cu-plating layer having a different grain size.

The thickness of the lower plating layers 34 is preferably about 1 μm to about 10 μm, for example.

The upper plating layers 36 include the first upper plating layer 36a, second upper plating layer 36b, third upper plating layer 36c, and fourth upper plating layer 36d.

The first upper plating layer 36a covers the first lower plating layer 34a. The second upper plating layer 36b covers the second lower plating layer 34b. The third upper plating layer 36c covers the third lower plating layer 34c. The fourth upper plating layer 36d covers the fourth lower plating layer 34d.

The upper plating layer 36 may include only a Sn-plating layer or may have a double-layer structure of a Ni-plating layer and a Sn-plating layer or a Ni-plating layer and a Cu-plating layer.

The thickness of the upper plating layer 36 is preferably about 1 μm to About 10 μm, for example.

The plating layers may include only the lower plating layers 34. In this case, the first lower plating layer 34a covers the first thin film layer 32a, and the second lower plating layer 34b covers the second thin film layer 32b. Likewise, the third lower plating layer 34c covers the third thin film layer 32c, and the fourth lower plating layer 34d covers the fourth thin film layer 32d.

The plating layers preferably include at least one of metals selected from Cu, Ni, Sn, Pb, Au, Ag, Pd, Bi, and Zn or an alloy including some of these metals. The plating layers preferably do not include glass.

The proportion of metal in the plating layers per unit volume preferably about 99% by volume or greater, for example.

The thickness of each plating layer is preferably about 0.5 μm to about 10.0 μm, for example.

In the outer electrodes 30 disposed on the first main surface 12a, as viewed in the stacking direction x, from intersection points between the outer electrode 30 and the multilayer body 12, straight lines are drawn in parallel to the first direction y and straight lines are drawn in parallel to the second direction z. Then, in one of the outer electrodes 30, at least one recess 40 protrudes inward from the outer edge of a first region R₁₀, which is defined by these straight lines, and inward from an edge portion of the outer electrode 30 close to the center of the multilayer body 12. The recesses 40 include a first recess 40a, a second recess 40b, a third recess 40c, and a fourth recess 40d.

The first recess 40a is provided in the first outer electrode 30a on the first main surface 12a.

The second recess 40b is provided in the second outer electrode 30b on the first main surface 12a.

The third recess 40c is provided in the third outer electrode 30c on the first main surface 12a.

The fourth recess 40d is provided in the fourth outer electrode 30d on the first main surface 12a.

The recess 40 will be explained more specifically by taking the first recess 40a provided in the first outer electrode 30a as an example.

As shown in FIG. 4A, as viewed in the stacking direction x, the intersection point of the first outer electrode 30a on the first main surface 12a, which is positioned closest to the first side surface 12c and the fourth side surface 12f, with the multilayer body 12 is set to a first intersection point P₁₁, and the intersection point of the first outer electrode 30a, which is positioned closest to the third side surface 12e and the second side surface 12d, with the multilayer body 12 is set to a second intersection point P₁₂. A straight line l₁₁ is drawn from the first intersection point P₁₁ in parallel to the first direction y. A straight line l₁₂ is drawn from the first intersection point P₁₁ in parallel to the second direction z. A straight line l₁₃ is drawn from the second intersection point P₁₂ in parallel to the first direction y. A straight line l₁₄ is drawn from the second intersection point P₁₂ in parallel to the second direction z. The region defined by the straight lines l₁₁, l₁₂, l₁₃, and l₁₄ is set to the first region R₁₀. Then, at least one first recess 40a protrudes inward from the outer edge of the first region R₁₀ and inward from at least one of the edge portions of the first outer electrode 30a close to the center of the multilayer body 12. More specifically, the first recess 40a provided in the first outer electrode 30a on the first main surface 12a of the multilayer ceramic capacitor 10 shown in FIG. 4A protrudes inward from the outer edge of the first region R₁₀ and inward from the edge portion of the first outer electrode 30a, which is one of the edge portions close to the center of the multilayer body 12 and is closest to the fourth side surface 12f.

The base portion of the first outer electrode 30a which starts to protrude inward at the edge portion close to the fourth side surface 12f so as to connect to the first recess 40a may be formed in a wavy shape. The dimension of the first recess 40a in the first direction y at the boundary with the edge portion of the first outer electrode 30a closest to the fourth side surface 12f is set to a dimension W1, and the dimension of the first recess 40a in the second direction z protruding inward from the edge portion of the first electrode 30a closest to the fourth side surface 12f is set to a dimension L1. The dimensions W1 and L1 can be set to desired dimensions. The dimension L1 is preferably about 10 μm or greater, for example. Then, the first recess 40a can be identified more clearly.

On the thin film layer 32 on the first main surface 12a, as viewed in the stacking direction x, from contact points between the thin film layer 32 defining the outer electrode 30 and the multilayer body 12, straight lines are drawn in parallel to the first direction y and straight lines are drawn in parallel to the second direction z. Then, in one of the thin film layers 32, at least one thin film layer recess 401 may be provided to protrude inward from the outer edge of a second region R₂₀, which is defined by these straight lines, and inward from an edge portion of the thin film layer 32a close to the center of the multilayer body 12.

The thin film layer recess 401 will be explained more specifically by taking a thin film layer recess provided in the first thin film layer 32a on the first main surface 12a as an example.

As shown in FIG. 4B(a), as viewed in the stacking direction x, the contact point of the first thin film layer 32a disposed on the first main surface 12a, which is positioned closest to the first side surface 12c and the fourth side surface 12f, with the multilayer body 12 is set to a first contact point P₂₁, and the contact point of the first thin film layer 32a, which is positioned closest to the third side surface 12e and the second side surface 12d, with the multilayer body 12 is set to a second contact point P₂₂. A straight line l₂₁ is drawn from the first contact point P₂₁ in parallel to the first direction y. A straight line l₂₂ is drawn from the first contact point P₂₁ in parallel to the second direction z. A straight line l₂₃ is drawn from the second contact point P₂₂ in parallel to the first direction y. A straight line l₂₄ is drawn from the second contact point P₂₂ in parallel to the second direction z. The region defined by the straight lines l₂₁, l₂₂, l₂₃, and l₂₄ is set to a second region R₂₀. Then, at least one first thin film layer recess 401a protrudes inward from the outer edge of the second region R₂₀ and inward from at least one of the edge portions of the first thin film layer 32a close to the center of the multilayer body 12. More specifically, the first thin film layer recess 401a provided in the first thin film layer 32a of the multilayer ceramic capacitor 10 shown in FIG. 4B(a) protrudes inward from the outer edge of the second region R₂₀ and inward from the edge portion of the first thin film layer 32a, which is one of the edge portions close to the center of the multilayer body 12 and is closest to the fourth side surface 12f.

The thin film layer recess 401 may be provided in the second through fourth thin film layers 32b through 32d in a manner similar to the first thin film layer recess 401a provided in the first thin film layer 32a as described above.

On the lower plating layer 34 disposed above the first main surface 12a, as viewed in the stacking direction x, from intersection points between the lower plating layer 34 of the outer electrode 30 and the multilayer body 12, straight lines are drawn in parallel to the first direction y and straight lines are drawn in parallel to the second direction z. Then, in one of the lower plating layers 34, at least one lower plating layer recess 402 may be provided to protrude inward from the outer edge of a third region R₃₀, which is defined by these straight lines, and inward from an edge portion of the lower plating layer 34 close to the center of the multilayer body 12.

The lower plating layer recess 402 will be explained more specifically by taking a lower plating layer recess provided in the first lower plating layer 34a disposed on the first main surface 12a as an example.

As shown in FIG. 4B(b), as viewed in the stacking direction x, the intersection point of the first lower plating layer 34a on the first main surface 12a, which is positioned closest to the first side surface 12c and the fourth side surface 12f, with the multilayer body 12 is set to a third intersection point P₃₁, and the intersection point of the lower plating layer 34a, which is positioned closest to the third side surface 12e and the second side surface 12d, with the multilayer body 12 is set to a fourth intersection point P₃₂. A straight line l₃₁ is drawn from the third intersection point P₃₁ in parallel to the first direction y. A straight line l₃₂ is drawn from the third intersection point P₃₁ in parallel to the second direction z. A straight line l₃₃ is drawn from the fourth intersection point P₃₂ in parallel to the first direction y. A straight line l₃₄ is drawn from the fourth intersection point P₃₂ in parallel to the second direction z. The region defined by the straight lines l₃₁, l₃₂, l₃₃, and l₃₄ is set to a third region R₃₀. Then, at least one first lower plating layer recess 402a protrudes inward from the outer edge of the third region R₃₀ and inward from at least one of the edge portions of the first lower plating layer 34a close to the center of the multilayer body 12. More specifically, the first lower plating layer recess 402a provided in the first lower plating layer 34a disposed on the first main surface 12a of the multilayer ceramic capacitor 10 shown in FIG. 4B(b) protrudes inward from the outer edge of the third region R₃₀ and inward from the edge portion of the first lower plating layer 34a, which is one of the edge portions close to the center of the multilayer body 12 and is closest to the fourth side surface 12f.

The lower plating layer recess 402 may be provided in the second through fourth lower plating layers 34b through 34d in a manner similar to the first lower plating layer recess 402a provided in the first lower plating layer 34a as described above.

The second through fourth outer electrodes 30b through 30d may be configured similarly to the first outer electrode 30a as described above. That is, at least one second recess 40b may be provided in the second outer electrode 30b, at least one third recess 40c may be provided in the third outer electrode 30c, and at least one fourth recess 40d may be provided in the fourth outer electrode 30d.

Regarding the arrangement of the recess 40 in the outer electrode 30, other examples will be discussed below specifically.

As illustrated in FIG. 4C(a), the first recess 40a provided in the first outer electrode 30a on the first main surface 12a protrudes inward from the outer edge of the first region R₁₀ and inward from the edge portion of the first outer electrode 30a, which is one of the edge portions close to the center of the multilayer body 12 and is closest to the second side surface 12d. The recess 40 may be provided in the second through fourth outer electrodes 30b through 30d in a manner similar to the first recess 40a provided in the first outer electrode 30a as described above.

As illustrated in FIG. 4C(b), multiple first recesses 40a₁ and 40a₂ may be provided in the first outer electrode 30a on the first main surface 12a. In this case, the first recess 40a₁ protrudes inward from the outer edge of the first region R₁₀ and inward from the edge portion of the first outer electrode 30a, which is one of the edge portions close to the center of the multilayer body 12 and is closest to the fourth side surface 12f. The first recess 40a₂ protrudes inward from the outer edge of the first region R₁₀ and inward from the edge portion of the first outer electrode 30a, which is one of the edge portions close to the center of the multilayer body 12 and is closest to the second side surface 12d. Multiple recesses 40 may be provided in the second through fourth outer electrodes 30b through 30d in a manner similar to the first recesses 40a₁ and 40a₂ provided in the first outer electrode 30a as described above.

As illustrated in FIG. 4C(c), multiple first recesses 40a₁ and 40a₂ may be provided in the first outer electrode 30a on the first main surface 12a. In this case, the first recesses 40a₁ and 40a₂ protrude inward from the outer edge of the first region R₁₀ and inward from the edge portion of the first outer electrode 30a, which is one of the edge portions close to the center of the multilayer body 12 and is closest to the fourth side surface 12f. Multiple first recesses may protrude inward from the outer edge of the first region R₁₀ and inward from the edge portion of the first outer electrode 30a, which is one of the edge portions close to the center of the multilayer body 12 and is closest to the second side surface 12d, though they are not shown. Multiple first recesses may protrude inward from the outer edge of the first region R₁₀ and inward from the edge portions of the first outer electrode 30a, one of the edge portions being close to the center of the multilayer body 12 and being closest to the fourth side surface 12f, the other edge portion being close to the center of the multilayer body 12 and being closest to the second side surface 12d. Multiple recesses 40 may be provided in the second through fourth outer electrodes 30b through 30d in a manner similar to the first recesses 40 provided in the first outer electrode 30a as described above.

A description has been given of the recess 40 provided in each of the first through fourth outer electrodes 30a through 30d on the first main surface 12a. However, a recess 40 may be provided in each of the first through fourth outer electrodes 30a through 30d on the second main surface 12b in a manner similar to the recesses 40 on the first main surface 12a.

The dimension of the multilayer ceramic capacitor 10 including the multilayer body 12 and the outer electrodes 30 in the first direction y is set to a dimension L. The dimension of the multilayer ceramic capacitor 10 including the multilayer body 12 and the outer electrodes 30 in the stacking direction x is set to a dimension T. The dimension of the multilayer ceramic capacitor 10 including the multilayer body 12 and the outer electrodes 30 in the second direction z is set to a dimension W.

As to the dimensions of the multilayer ceramic capacitor 10, the dimension L in the first direction y is preferably about 0.2 mm to about 3.2 mm, the dimension T in the stacking direction x is preferably about 0.04 mm to about 0.22 mm, and the dimension W in the second direction z is preferably about 0.2 mm to about 3.2 mm, for example. The dimensions of the multilayer ceramic capacitor 10 are preferably those expressed by about 7/10≤L/W≤about 10/7, for example. With this arrangement, the multilayer body 12 can have a substantially tetragonal shape, thus improving the flexibility in mounting the multilayer ceramic capacitor 10.

In the multilayer ceramic capacitor 10 shown in FIG. 1, at least one recess 40 protrudes inward from the outer edge of the first region R₁₀ of the outer electrode 30, which is defined by straight lines drawn from intersection points between the outer electrode 30 and the multilayer body 12 in parallel to the first direction y and the second direction z, and inward from an edge portion of the outer electrode 30 close to the center of the multilayer body 12. With this configuration, by checking the presence/absence and the size of the recess 40 with an image sensor or another device, the specifications and certain characteristics of the multilayer ceramic capacitor can be determined.

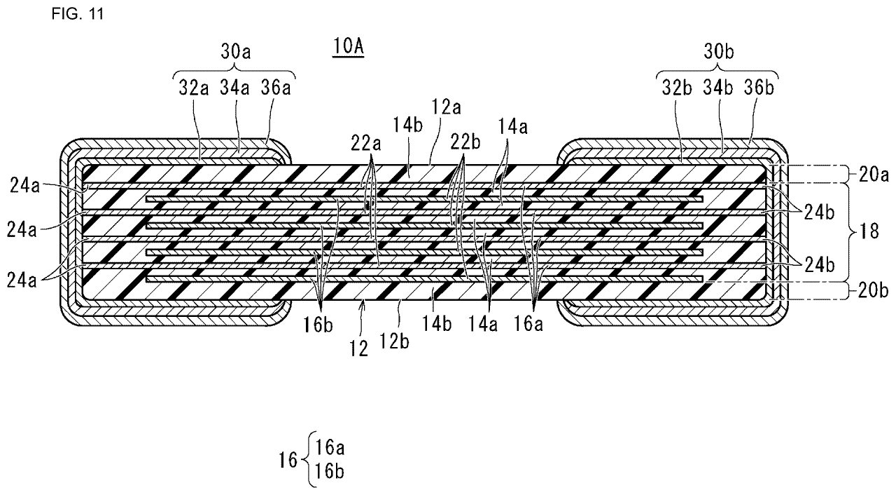

An example of a multilayer ceramic capacitor 10A according to a first modified example of the first example embodiment of the present invention will now be described below. FIG. 11 is a schematic sectional view illustrating an example of a multilayer ceramic capacitor according to the first modified example of the first example embodiment of the present invention. Identical or corresponding elements to those in FIGS. 1 through 10 are designated by like reference numerals and a detailed explanation thereof will be omitted.

In the multilayer ceramic capacitor 10A according to the first modified example, the thin film layer 32 extends to the side surfaces of the multilayer body 12, as shown in FIG. 11.

More specifically, the first thin film layer 32a of the first outer electrode 30a covers a portion of the first main surface 12a and a portion of the second main surface 12b and also to extend from the main surfaces to cover the first and third side surfaces 12c and 12e.

The second thin film layer 32b of the second outer electrode 30b covers a portion of the first main surface 12a and a portion of the second main surface 12b and also to extend from the main surfaces to cover the second and fourth side surfaces 12d and 12f.

The third thin film layer 32c of the third outer electrode 30c and the fourth thin film layer 32d of the fourth outer electrode 30d are configured similarly to the first and second thin film layers 32a and 32b, though they are not shown.

The first thin film layer 32a is directly electrically connected to the first extending electrode portions 24a of the first inner electrodes 16a exposed on the first and third side surfaces 12c and 12e. The second thin film layer 32b is directly electrically connected to the second extending electrode portions 24b of the first inner electrodes 16a exposed on the second and fourth side surfaces 12d and 12f.

The third thin film layer 32c is directly electrically connected to the third extending electrode portions 24c of the second inner electrodes 16b, and the fourth thin film layer 32d is directly electrically connected to the fourth extending electrode portions 24d of the second inner electrodes 16b, though they are not shown.

The first thin film layer 32a on the first and second main surfaces 12a and 12b and on the first and third side surfaces 12c and 12e may be formed continuously or be formed discontinuously. The second thin film layer 32b on the first and second main surfaces 12a and 12b and on the second and fourth side surfaces 12d and 12f may be formed continuously or be formed discontinuously.

The third thin film layer 32c of the third outer electrode 30c and the fourth thin film layer 32d of the fourth outer electrode 30d may be configured similarly to the first and second thin film layers 32a and 32b.

The multilayer ceramic capacitor 10A of the first example embodiment shown in FIG. 11 achieves advantages similar to those of the above-described multilayer ceramic capacitor 10.

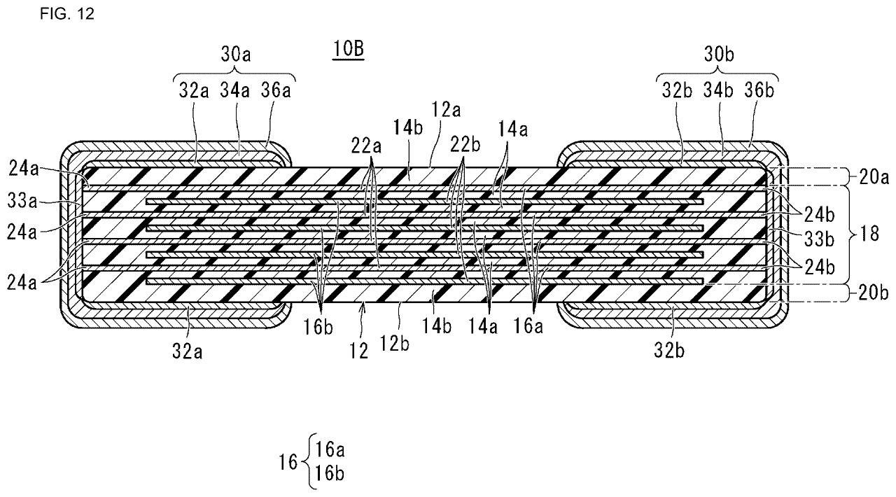

An example of a multilayer ceramic capacitor 10B according to a second modified example of the first example embodiment of the present invention will now be described below. FIG. 12 is a schematic sectional view illustrating an example of a multilayer ceramic capacitor according to the second modified example of the first example embodiment of the present invention. Identical or corresponding elements to those in FIGS. 1 through 10 are designated by like reference numerals and a detailed explanation thereof will be omitted.

The outer electrode 30 of the multilayer ceramic capacitor 10B according to the second modified example of the first example embodiment includes a direct plating layer 33, as shown in FIG. 12.

The first outer electrode 30a includes a first direct plating layer 33a, and the second outer electrode 30b includes a second direct plating layer 33b. The third outer electrode 30c includes a third direct plating layer, and the fourth outer electrode 30d includes a fourth direct plating layer, though the third and fourth direct plating layers are not shown.

The first direct plating layer 33a covers a portion the first side surface 12c and a portion of the third side surface 12e of the multilayer body 12 and also covers the ridge portions sandwiched between the first and third side surfaces 12c and 12e. The first direct plating layer 33a is directly electrically connected to the first extending electrode portions 24a of the first inner electrodes 16a.

The second direct plating layer 33b covers a portion the second side surface 12d and a portion of the fourth side surface 12f of the multilayer body 12 and also covers the ridge portions sandwiched between the second and fourth side surfaces 12d and 12f. The second direct plating layer 33b is directly electrically connected to the second extending electrode portions 24b of the first inner electrodes 16a.

The third direct plating layer of the third outer electrode 30c and the fourth direct plating layer of the fourth outer electrode 30d are configured similarly to the first and second direct plating layers 33a and 33b as described above, though they are not shown.

The top end of the first direct plating layer 33a of the first outer electrode 30a preferably overlaps the bottom side of the first thin film layer 32a on the ridge portion between the first main surface 12a, the first side surface 12c, and the third side surface 12e of the multilayer body 12.

The top end of the second direct plating layer 33b of the second outer electrode 30b preferably overlaps the bottom side of the second thin film layer 32b on the ridge portion between the first main surface 12a, the second side surface 12d, and the fourth side surface 12f of the multilayer body 12.

The third direct plating layer of the third outer electrode 30c and the fourth direct plating layer of the fourth outer electrode 30d are configured in a manner similar to the first and second direct plating layers 33a and 33b as described above, though they are not shown.

A portion of the first direct plating layer 33a may extend to the second main surface 12b, and a portion of the second direct plating layer 33b may extend to the second main surface 12b. A portion of the third direct plating layer and a portion of the fourth direct plating layer may also extend to the second main surface 12b.

The top end of the first direct plating layer 33a and that of the second direct plating layer 33b may be separate from the first thin film layer 32a and the second thin film layer 32b, respectively. The top end of the third direct plating layer and that of the fourth direct plating layer may be separate from the third thin film layer 32c and the fourth thin film layer 32d, respectively.

The material of the direct plating layer 33 is not particularly limited if it contains at least one of elements selected from Cu, Ni, Ag, Pd, an Ag—Pd alloy, and Au, for example, as a metal main component. If, for example, the first and second inner electrodes 16a and 16b include Ni, the direct plating layers 33 preferably use Cu plating having good adhesion with Ni.

The direct plating layer 33 is formed by the growth of a plating metal from the inner electrode 16.

The thickness of each direct plating layer 33 is preferably about 0.5 μm to about 10.0 μm, for example.

The multilayer ceramic capacitor 10B of the first example embodiment shown in FIG. 12 achieves advantages similar to those of the above-described multilayer ceramic capacitor 10.

More specifically, because of the formation of the direct plating layer 33 on each side surface of the multilayer body 12, the thickness of the outer electrode 30 on the first and second main surfaces 12a and 12b in the stacking direction can further be reduced. It is thus possible to provide a multilayer ceramic capacitor that can be further reduced in height without impairing its mountability.

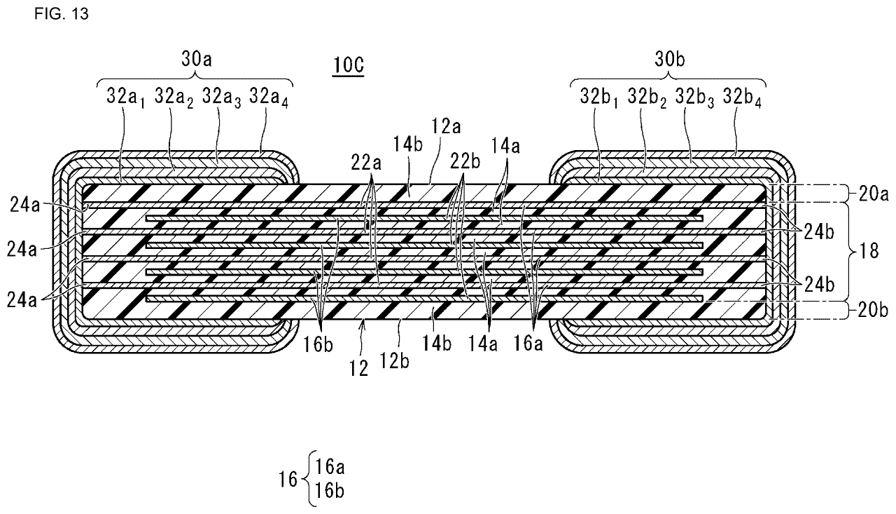

An example of a multilayer ceramic capacitor 10C according to a third modified example of the first example embodiment of the present invention will now be described below. FIG. 13 is a schematic sectional view illustrating an example of a multilayer ceramic capacitor according to the third modified example of the first example embodiment of the present invention. Identical or corresponding elements to those in FIGS. 1 through 10 are designated by like reference numerals and a detailed explanation thereof will be omitted.

The outer electrode 30 of the multilayer ceramic capacitor 10C according to the third modified example does not include any plating layer and includes multiple thin film layers. In the multilayer ceramic capacitor 10C shown in FIG. 13, the first outer electrode 30a includes only four thin film layers 32a₁ through 32a₄ without including any plating layer, and the second outer electrode 30b includes only four thin film layers 32b₁ through 32b₄ without including any plating layer.

In the first outer electrode 30a, the thin film layer 32a₁ extends from the first main surface 12a to cover the first and third side surfaces 12c and 12e. Then, the thin film layers 32a₂, 32a₃, 32a₄ are sequentially formed on the surface of the thin film layer 32a₁.

In the second outer electrode 30b, the thin film layer 32b₁ extends from the first main surface 12a to cover the second and fourth side surfaces 12d and 12f. Then, the thin film layers 32b₂, 32b₃, 32b₄ are sequentially formed on the surface of the thin film layer 32b₁.

The third thin film layer 32c of the third outer electrode 30c and the fourth thin film layer 32d of the fourth outer electrode 30d are also configured similarly to the first and second thin film layers 32a and 32b, though they are not shown.

In the first outer electrode 30a, the edge portion of each of the four thin film layers 32a₁ through 32a₄ toward the center of the multilayer body 12 may cover the edge portion of the corresponding lower layer, though this is not essential. Likewise, in the second outer electrode 30b, the edge portion of each of the four thin film layers 32b₁ through 32b₄ toward the center of the multilayer body 12 may cover the edge portion of the corresponding lower layer, though this is not essential.

The third thin film layer 32c of the third outer electrode 30c and the fourth thin film layer 32d of the fourth outer electrode 30d may be configured similarly to the first and second thin film layers 32a and 32b as described above, though they are not shown.

The multilayer ceramic capacitor 10C of the first example embodiment shown in FIG. 13 achieves advantages similar to those of the above-described multilayer ceramic capacitor 10 and also achieves the following advantage.

In the multilayer ceramic capacitor 10C, the first outer electrode 30a includes only the thin film layers 32a₁ through 32a₄ without including any plating layer, and the second outer electrode 30b includes only the thin film layers 32b₁ through 32b₄ without including any plating layer. Additionally, the third and fourth outer electrodes 30c and 30d are also configured similarly. With this configuration, the dimension T in the stacking direction x, the dimension L in the first direction y, and the dimension W in the second direction z can be significantly reduced, thus implementing the multilayer ceramic capacitor having a smaller size.

A non-limiting example of a manufacturing method for a multilayer ceramic capacitor, which is an example of the multilayer ceramic capacitor of the first example embodiment, will be described below.

First, dielectric sheets and a conductive paste for inner electrodes are prepared. The dielectric sheets and the conductive paste include a binder and a solvent. A known binder and a known solvent can be used.

Then, the conductive paste is applied onto the dielectric sheets to have a predetermined pattern via a certain printing method, such as inkjet printing, screen printing, or gravure printing. Then, dielectric sheets on which a pattern of the first inner electrode is formed and dielectric sheets on which a pattern of the second inner electrode is formed are prepared. Then, the sheets having the first inner electrode printed thereon and those having the second inner electrode printed thereon are alternately stacked on each other, thus forming a base of the inner layer section 18.

Subsequently, a predetermined number of dielectric sheets without the pattern of the inner electrode are stacked to form a base of the first outer layer section 20a to face the first main surface 12a. Then, the base of the inner layer section 18 is stacked, and a predetermined number of dielectric sheets without the pattern of the inner electrode are stacked on the base of the inner layer section 18, thus forming a base of the second outer layer section 20b to face the second main surface 12b. As a result, multilayer sheets are formed.

Subsequently, the multilayer sheets are pressed in the stacking direction via a certain technique, such as hydrostatic pressing, to form a multilayer block.

Then, the multilayer block is cut into a predetermined size to obtain multilayer chips. During this step, the corners and the ridge portions of the multilayer chips may be rounded by barrel polishing or another technique.

Subsequently, the multilayer chips are fired to form the multilayer body 12. The firing temperature is preferably about 900° C. to about 1400° C., for example, though it depends on the type of ceramic and the material of the inner electrodes.

The obtained multilayer body 12 is arranged on a work table, and the thin film layers 32 are formed on the first and second main surfaces 12a and 12b by sputtering.

During this step, each thin film layer 32 is formed into a desired shape.

More specifically, a mask is prepared to provide at least one recess 40 protruding outward from an edge portion of the thin film layer 32, which is close to the center of the multilayer body 12, of the outer electrode 30 of the invention. By using this mask, the thin film layer 32 can be formed into a desired shape.

Then, the lower plating layer 34 is formed on the thin film layer 32 and the surface of the multilayer body 12, and the upper plating layer 36 is formed to cover the lower plating layer 34. More specifically, a Cu plating layer is formed on the thin film layer 32 as the lower plating layer 34, and then, a Ni plating layer and a Sn plating layer are formed on the surface of the lower plating layer 34 as the upper plating layer 36. As plating, either electrolytic plating or electroless plating may be used. However, electroless plating requires pretreatment with a catalyst or another substance to improve the plating deposition rate, which makes the process complicated. Usually, therefore, electrolytic plating is preferable.

The multilayer ceramic capacitor 10 of the example embodiment shown in FIG. 1 can be manufactured as described above. To manufacture the multilayer ceramic capacitor 10A of the first modified example in FIG. 11, the multilayer ceramic capacitor 10B of the second modified example in FIG. 12, and the multilayer ceramic capacitor 10C of the third modified example in FIG. 13, the shapes of the corresponding elements are appropriately changed in the individual steps.

An example of a multilayer ceramic capacitor 110 according to a second example embodiment of the present invention will now be described below.

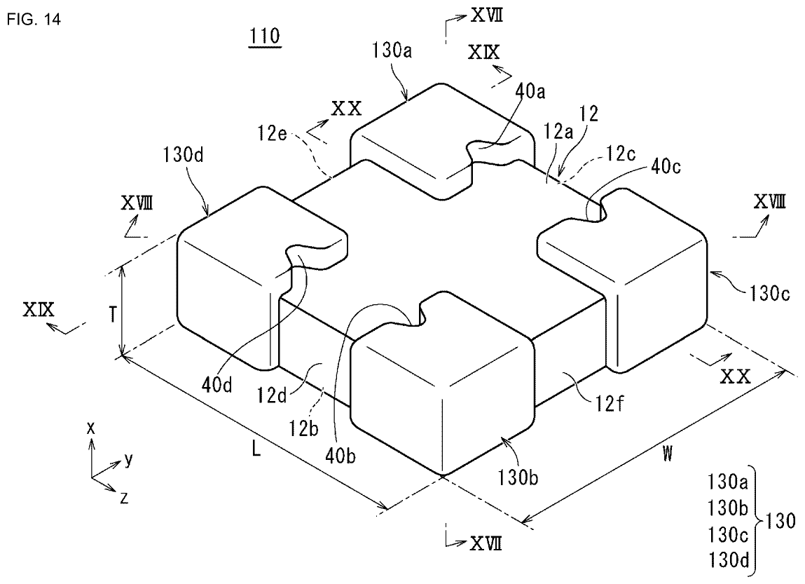

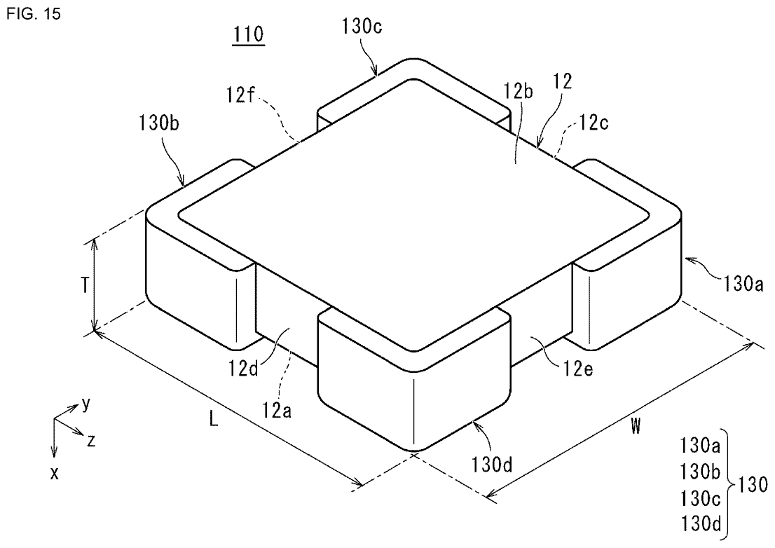

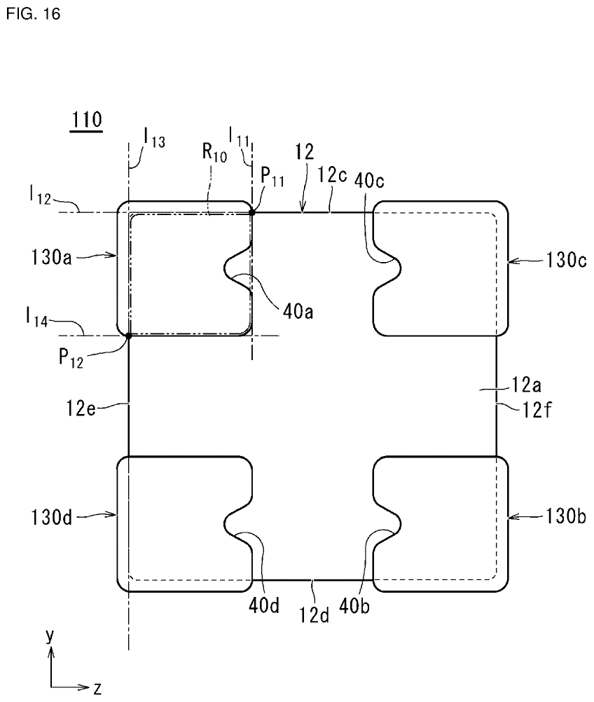

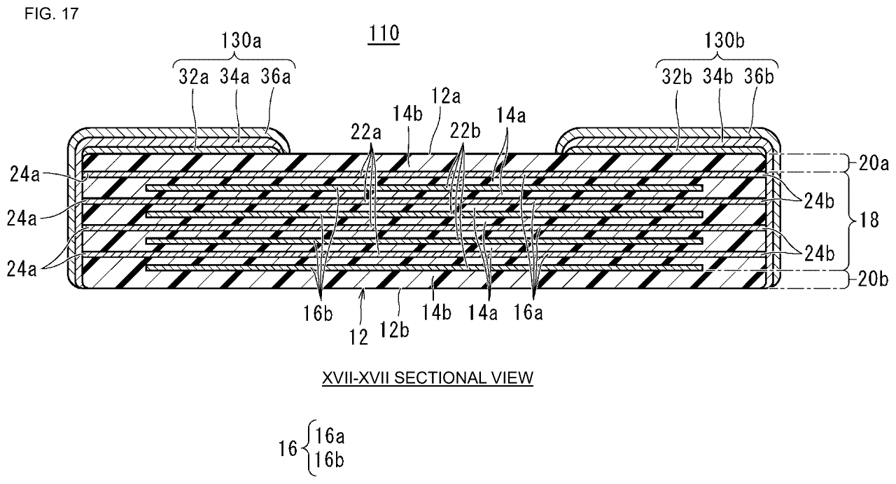

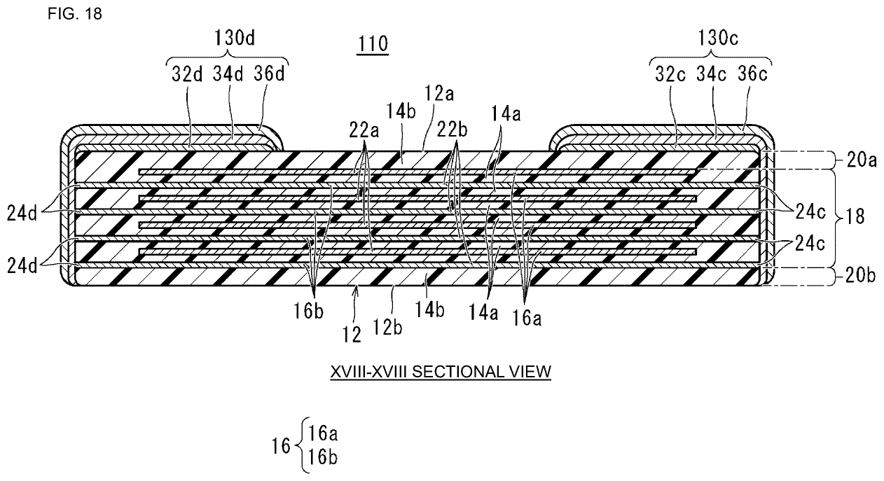

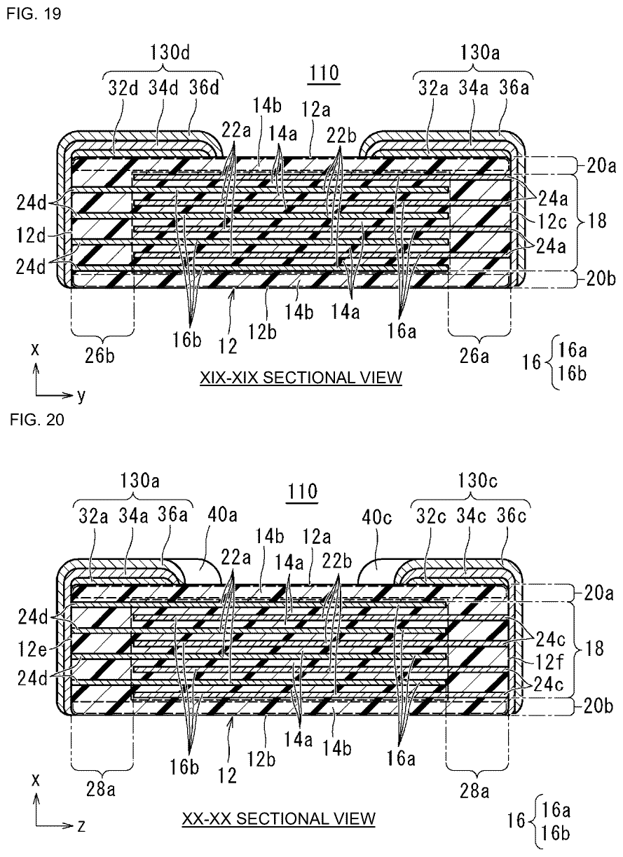

FIG. 14 is an external perspective view illustrating an example of a multilayer ceramic capacitor according to the second example embodiment of the present invention when the multilayer ceramic capacitor is viewed from one side. FIG. 15 is an external perspective view illustrating an example of the multilayer ceramic capacitor according to the second example embodiment of the present invention when the multilayer ceramic capacitor is viewed from another side. FIG. 16 is a plan view illustrating an example of the multilayer ceramic capacitor according to the second example embodiment of the present invention. FIG. 17 is a schematic sectional view taken along line XVII-XVII in FIG. 14 and illustrates the structure of an example of the multilayer ceramic capacitor according to the second example embodiment of the present invention. FIG. 18 is a schematic sectional view taken along line XVIII-XVIII in FIG. 14. FIG. 19 is a schematic sectional view taken along line XIX-XIX in FIG. 14. FIG. 20 is a schematic sectional view taken along line XX-XX in FIG. 14. Identical or corresponding elements to those in FIGS. 1 through 8 are designated by like reference numerals and a detailed explanation thereof will be omitted.

The configuration of the multilayer body 12 of the multilayer ceramic capacitor 110 of the second example embodiment is similar to that of the multilayer body 12 of the first example embodiment of the present invention shown in FIG. 1.

The first inner electrodes 16a of the inner electrodes 16 extend to the first side surface 12c and the third side surface 12e of the multilayer body 12 via the first extending electrode portions 24a and extend to the second side surface 12d and the fourth side surface 12f of the multilayer body 12 via the second extending electrode portions 24b.

The second inner electrodes 16b of the inner electrodes 16 extend to the first side surface 12c and the fourth side surface 12f of the multilayer body 12 via the third extending electrode portions 24c and extend to the second side surface 12d and the third side surface 12e of the multilayer body 12 via the fourth extending electrode portions 24d.

In the multilayer ceramic capacitor 110 of the second example embodiment, an outer electrode 130 covers the first main surface 12a of the multilayer body 12 but does not cover the second main surface 12b.

The outer electrodes 130 are disposed on the multilayer body 12, as illustrated in FIGS. 14 through 20.

The outer electrodes 130 include multiple outer electrodes 130 connected to the first and second inner electrodes 16a and 16b. The outer electrodes 130 include a first outer electrode 130a, a second outer electrode 130b, a third outer electrode 130c, and a fourth outer electrode 130d.

The first outer electrode 130a covers the first extending electrode portions 24a of the first inner electrodes 16a on the first and third side surfaces 12c and 12e and also covers a portion the first main surface 12a. The first outer electrode 130a is electrically connected to the first extending electrode portions 24a of the first inner electrodes 16a.

The second outer electrode 130b covers the second extending electrode portions 24b of the first inner electrodes 16a on the second and fourth side surfaces 12d and 12f and also covers a portion the first main surface 12a. The second outer electrode 130b is electrically connected to the second extending electrode portions 24b of the first inner electrodes 16a.

The third outer electrode 130c covers the third extending electrode portions 24c of the second inner electrodes 16b on the first and fourth side surfaces 12c and 12f and also covers a portion the first main surface 12a. The third outer electrode 130c is electrically connected to the third extending electrode portions 24c of the second inner electrodes 16b.

The fourth outer electrode 130d covers the fourth extending electrode portions 24d of the second inner electrodes 16b on the second and third side surfaces 12d and 12e and also covers a portion the first main surface 12a. The fourth outer electrode 130d is electrically connected to the fourth extending electrode portions 24d of the second inner electrodes 16b.

On the outer electrode 130 disposed on the first main surface 12a, from intersection points between the outer electrode 130 and the multilayer body 12, straight lines are drawn in parallel to the first direction y and straight lines are drawn in parallel to the second direction z. Then, in the outer electrode 130, at least one recess 40 protrudes inward from the outer edge of a first region R₁₀, which is defined by these straight lines, and inward from an edge portion of the outer electrode 130 close to the center of the multilayer body 12. The recesses 40 include a first recess 40a, a second recess 40b, a third recess 40c, and a fourth recess 40d.

The first recess 40a is provided in the first outer electrode 130a on the first main surface 12a.

The second recess 40b is provided in the second outer electrode 130b disposed on the first main surface 12a.

The third recess 40c is provided in the third outer electrode 130c disposed on the first main surface 12a.

The fourth recess 40d is provided in the fourth outer electrode 130d on the first main surface 12a.

The recess 40 will be explained specifically by taking the first recess 40a provided in the first outer electrode 130a as an example.

As shown in FIG. 16, as viewed in the stacking direction x, the intersection point of the first outer electrode 130a on the first main surface 12a, which is positioned closest to the first side surface 12c and the fourth side surface 12f, with the multilayer body 12 is set to a first intersection point P₁₁, and the intersection point of the first outer electrode 130a, which is positioned closest to the third side surface 12e and the second side surface 12d, with the multilayer body 12 is set to a second intersection point P₁₂. A straight line l₁₁ is drawn from the first intersection point P₁₁ in parallel to the first direction y. A straight line l₁₂ is drawn from the first intersection point P₁₁ in parallel to the second direction z. A straight line l₁₃ is drawn from the second intersection point P₁₂ in parallel to the first direction y. A straight line l₁₄ is drawn from the second intersection point P₁₂ in parallel to the second direction z. The region defined by the straight lines l₁₁, l₁₂, l₁₃, and l₁₄ is set to the first region R₁₀. Then, at least one first recess 40a protrudes inward from the outer edge of the first region R₁₀ and inward from at least one of the edge portions of the first outer electrode 130a close to the center of the multilayer body 12. More specifically, the first recess 40a provided in the first outer electrode 130a on the first main surface 12a of the multilayer ceramic capacitor 110 shown in FIG. 16 protrudes inward from the outer edge of the first region R₁₀ and inward from the edge portion of the first outer electrode 130a, which is one of the edge portions close to the center of the multilayer body 12 and is closest to the fourth side surface 12f.

The second through fourth outer electrodes 130b through 130d may be configured similarly to the first outer electrode 130a as described above. That is, at least one second recess 40b may be provided in the second outer electrode 130b, at least one third recess 40c may be provided in the third outer electrode 130c, and at least one fourth recess 40d may be provided in the fourth outer electrode 130d.

The recess 40 may be arranged in the outer electrode 130 of the multilayer ceramic capacitor 110 of the second example embodiment as in the examples of the recess 40 arranged in the outer electrode 30 discussed with reference to FIG. 4C(a) through FIG. 4C(c).

The multilayer ceramic capacitor 110 of the second example embodiment shown in FIGS. 14 through 20, in which the outer electrode 130 covers only the first main surface 12a of the multilayer body 12 but does not cover the second main surface 12b, can also be reduced in height without impairing the mountability, as in the multilayer ceramic capacitor 10 shown in FIG. 1.

In the multilayer ceramic capacitor 110 of the second example embodiment, the outer electrode 130 may cover a portion of the second main surface 12b but does not cover the first main surface 12a.

The multilayer ceramic capacitor 110 of the second example embodiment of the present invention may be combined with all or some of the above-described first through third modified examples. The multilayer ceramic capacitor 110 of the second example embodiment may be combined with all or some of the above-described first through third modified examples of the multilayer ceramic capacitor 10 of the first example embodiment and other modified examples in the drawings.

A non-limiting example of a manufacturing method for a multilayer ceramic capacitor, which is an example of the multilayer ceramic capacitor of the second example embodiment, will be described below.

First, dielectric sheets and a conductive paste for inner electrodes are prepared. The dielectric sheets and the conductive paste include a binder and a solvent. A known binder and a known solvent can be used.

Then, the conductive paste is applied onto the dielectric sheets to have a predetermined pattern via a certain printing method, such as inkjet printing, screen printing, or gravure printing. Then, dielectric sheets on which a pattern of the first inner electrode is formed and dielectric sheets on which a pattern of the second inner electrode is formed are prepared. Then, the sheets having the first inner electrode printed thereon and those having the second inner electrode printed thereon are alternately stacked on each other, thus forming a base of the inner layer section 18.

Subsequently, a predetermined number of dielectric sheets without the pattern of the inner electrode are stacked to form a base of the first outer layer section 20a to face the first main surface 12a. Then, the base of the inner layer section 18 is stacked, and a predetermined number of dielectric sheets without the pattern of the inner electrode are stacked on the base of the inner layer section 18, thus forming a base of the second outer layer section 20b to face the second main surface 12b. As a result, multilayer sheets are formed.

Subsequently, the multilayer sheets are pressed in the stacking direction via a certain technique, such as hydrostatic pressing, to form a multilayer block.

Then, the multilayer block is cut into a predetermined size to obtain multilayer chips. During this step, the corners and the ridge portions of the multilayer chips may be rounded by barrel polishing or another technique.

Subsequently, the multilayer chips are fired to form the multilayer body 12. The firing temperature is preferably about 900° C. to about 1400° C., for example, depending on the type of ceramic and the material of the inner electrodes.

The obtained multilayer body 12 is arranged on a work table, and the thin film layers 32 are formed on the first main surface 12a by sputtering.

During this step, each thin film layer 32 is formed into a desired shape.

More specifically, a mask is prepared to provide at least one recess 40 protruding outward from an edge portion of the thin film layer 32, which is close to the center of the multilayer body 12, of the outer electrode 130 of the invention. By using this mask, the thin film layer 32 can be formed into a desired shape.

Then, the lower plating layer 34 is formed on the thin film layer 32 and the surface of the multilayer body 12, and the upper plating layer 36 is formed to cover the lower plating layer 34. More specifically, a Cu plating layer is formed on the thin film layer 32 as the lower plating layer 34, and then, a Ni plating layer and a Sn plating layer are formed on the surface of the lower plating layer 34 as the upper plating layer 36. As plating, either electrolytic plating or electroless plating may be used. However, electroless plating requires pretreatment with a catalyst or another substance to improve the plating deposition rate, which makes the process complicated. Usually, therefore, electrolytic plating is preferable.

The multilayer ceramic capacitor 110 of the second example embodiment shown in FIG. 16 can be manufactured as described above.

By using the manufacturing method for the multilayer ceramic capacitor of this example embodiment, the thickness of the dimension T of the outer electrodes 130 in the stacking direction x formed on the first main surfaces 12a can be reduced. It is thus possible to provide a multilayer ceramic capacitor that can be reduced in height without impairing its mountability.

Example embodiments of the present invention have been disclosed above, but the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including first and second main surfaces opposing each other in a stacking direction of layers, first and second side surfaces opposing each other in a first direction, the first direction being perpendicular to the stacking direction, and third and fourth side surfaces opposing each other in a second direction, the second direction being perpendicular to the stacking direction and the first direction;
a first outer electrode on the first and third side surfaces and on the first main surface;
a second outer electrode on the second and fourth side surfaces and on the first main surface;
a third outer electrode on the first and fourth side surfaces and on the first main surface; and
a fourth outer electrode on the second and third side surfaces and on the first main surface; wherein
in the first outer electrode on the first main surface, as viewed in the stacking direction, straight lines are drawn in parallel to the first direction and in parallel to the second direction from an intersection point between the first outer electrode and the multilayer body, and, in the first outer electrode, at least one recess protrudes inward from an outer edge of a region defined by the straight lines and inward from an edge portion of the first outer electrode, the edge portion being at or adjacent to a center of the multilayer body.

2. The multilayer ceramic capacitor according to claim 1, wherein dimensions of the multilayer ceramic capacitor are expressed by about 7/10≤L/W≤about 10/7, where L is a dimension of the multilayer ceramic capacitor in the first direction and W is a dimension of the multilayer ceramic capacitor in the second direction.

3. The multilayer ceramic capacitor according to claim 1, wherein the first outer electrode includes two or more recesses.

4. The multilayer ceramic capacitor according to claim 1, wherein
in the second outer electrode on the first main surface, as viewed in the stacking direction, straight lines are drawn in parallel to the first direction and in parallel to the second direction from an intersection point between the second outer electrode and the multilayer body; and
in the second outer electrode, at least one recess protrudes inward from an outer edge of a region defined by the straight lines and inward from an edge portion of the second outer electrode, the edge portion being at or adjacent to a center of the multilayer body.

5. The multilayer ceramic capacitor according to claim 4, wherein the second outer electrode includes two or more recesses.

6. The multilayer ceramic capacitor according to claim 1, wherein
in the third outer electrode on the first main surface, as viewed in the stacking direction, straight lines are drawn in parallel to the first direction and in parallel to the second direction from an intersection point between the third outer electrode and the multilayer body; and
in the third outer electrode, at least one recess protrudes inward from an outer edge of a region defined by the straight lines and inward from an edge portion of the third outer electrode, the edge portion being at or adjacent to a center of the multilayer body.

7. The multilayer ceramic capacitor according to claim 6, wherein the third outer electrode has two or more recesses.

8. The multilayer ceramic capacitor according to claim 1, wherein the first outer electrode has a square or substantially square shape.

9. The multilayer ceramic capacitor according to claim 1, wherein at least one of the second through fourth outer electrodes has a square or substantially square shape.

10. The multilayer ceramic capacitor according to claim 8, wherein at least one of the second through fourth outer electrodes has a square or substantially square shape.

11. A multilayer ceramic capacitor comprising:
a multilayer body including first and second main surfaces opposing each other in a stacking direction of layers, first and second side surfaces opposing each other in a first direction, the first direction being perpendicular to the stacking direction, and third and fourth side surfaces opposing each other in a second direction, the second direction being perpendicular to the stacking direction and the first direction;
a first outer electrode on the first and third side surfaces and on the first main surface;
a second outer electrode on the second and fourth side surfaces and on the first main surface;
a third outer electrode on the first and fourth side surfaces and on the first main surface; and
a fourth outer electrode on the second and third side surfaces and on the first main surface; wherein
the first outer electrode includes:
a first thin film layer on the first main surface;
a first lower plating layer on the first and third side surfaces; and
a first upper plating layer on the first lower plating layer;
the second outer electrode includes:
a second thin film layer on the first main surface;
a second lower plating layer on the second and fourth side surfaces; and
a second upper plating layer on the second lower plating layer;
the third outer electrode includes:
a third thin film layer on the first main surface;
a third lower plating layer on the first and fourth side surfaces; and
a third upper plating layer on the third lower plating layer;
the fourth outer electrode includes:
a fourth thin film layer on the first main surface;
a fourth lower plating layer on the second and third side surfaces; and
a fourth upper plating layer on the fourth lower plating layer;
in the first thin film layer on the first main surface, as viewed in the stacking direction, straight lines are drawn in parallel to the first direction and in parallel to the second direction from a contact point between the first thin film layer and the multilayer body, and, in the first thin film layer, at least one recess protrudes inward from an outer edge of a region defined by the straight lines and inward from an edge portion of the first thin film layer, the edge portion being at or adjacent to a center of the multilayer body.

12. The multilayer ceramic capacitor according to claim 11, wherein the first thin film layer includes two or more recesses.

13. The multilayer ceramic capacitor according to claim 11, wherein
in the second thin film layer on the first main surface, as viewed in the stacking direction, straight lines are drawn in parallel to the first direction and in parallel to the second direction from an intersection point between the second thin film layer and the multilayer body; and
in the second thin film layer, at least one recess protrudes inward from an outer edge of a region defined by the straight lines and inward from an edge portion of the second thin film layer, the edge portion being at or adjacent to a center of the multilayer body.

14. The multilayer ceramic capacitor according to claim 13, wherein the second thin film layer includes two or more recesses.

15. The multilayer ceramic capacitor according to claim 11, wherein
in the third thin film layer on the first main surface, as viewed in the stacking direction, straight lines are drawn in parallel to the first direction and in parallel to the second direction from an intersection point between the third thin film layer and the multilayer body; and
in the third thin film layer, at least one recess protrudes inward from an outer edge of a region defined by the straight lines and inward from an edge portion of the third thin film layer, the edge portion being at or adjacent to a center of the multilayer body.

16. The multilayer ceramic capacitor according to claim 15, wherein the third thin film layer includes two or more recesses.

17. The multilayer ceramic capacitor according to claim 11, wherein the first thin film layer has a square or substantially square shape.

18. The multilayer ceramic capacitor according to claim 11, wherein at least one of the second through fourth thin film layers has a square or substantially square shape.

19. The multilayer ceramic capacitor according to claim 17, wherein at least one of the second through fourth thin film layers has substantially square shape.
